(19) United States
(12) Patent Application Publication
(10) Pub. No.: US 2013/0108917 A1
(43) Pub. Date: May 2, 2013

(54) ELECTROCHEMICAL DEVICE

(71) Applicants: Yuki Kawai, Taito-ku (JP); Katsuei Ishida, Taito-ku (JP)

(72) Inventors: Yuki Kawai, Taito-ku (JP); Katsuei Ishida, Taito-ku (JP)

(21) Appl. No.: 13/574,533

(22) PCT Filed: Jan. 11, 2011
(86) PCT No.: PCT/JP2011/050243

§ 371 Date: Jan. 15, 2013

(30) Foreign Application Priority Data
Jan. 21, 2010 (JP) 2010-010676

(51) Int. Cl. H01M 2/06

(52) U.S. Cl. CPC H01M 2/06
USPC 429/179

(57) ABSTRACT

An electrochemical device free of any void connecting the inside and outside of a film package upon reflow soldering may be provided. Electrochemical device RB1 according to one embodiment comprises film package 14 having terminal-sealing sections 14c; electric storage element 11; seal auxiliary members 13; terminals 12 each electrically connected to the electric storage element 11 at one end and led out of the film package 14 via the corresponding terminal-sealing section 14c at the other end. The film package 14 is provided with support member 14d on its front edge. Provided on a part of the terminals 12 are heat seal auxiliary members 13, the rear ends of which are integrated with the terminal-sealing section 14c by thermal fusion bonding. The other end of the heat seal auxiliary member 13 projects outwardly from the terminal-sealing section 14c so as to be disposed on the support member 14d.

### TECHNICAL FIELD

The present invention relates to an electrochemical device comprising an electric storage element enclosed within a film package.

### BACKGROUND

The background of the invention is hereinafter explained in accordance with accompanying drawings. For ease of describing, the direction toward the viewer, away from the viewer, left, right, top and bottom in FIG. 1 (A) will be referred to as “top,” “bottom,” “front,” “rear,” “left,” and “right” respectively, while the corresponding directions in other drawings are also referred to as “top,” “bottom,” “front,” “rear,” “left,” and “right” respectively.

FIGS. 1(A) and 1(B) illustrate a conventional electrochemical device RB. The electrochemical device RB comprises an electric storage element 101, a pair of terminals 102 electrically connected to the electric storage element 101, and a film package 103 wherein the electric storage element 101 is enclosed.

The electric storage element 101 is substantially rectangular in top view and has a laminated structure including one or more collecting electrode layers, one or more polarizable electrode layers, and one or more separate films are laminated in that order. A pair of rectangular terminal connections are formed integrally with each of the collecting electrode layers at their front edges. Each of the left and right sides of the terminal connections has a different polar character from one another.

Each of the pair of terminals 102 is substantially rectangular in top view. The rear edge of one of the terminals 102 is electrically connected to one of the terminal connections of the electric storage element 101, and the rear edge of the other of the terminals 102 is electrically connected to the other of the terminal connections of the electric storage element 101. Each of the terminals 102 is generally formed of conductive materials such as aluminum or platinum.

The film package 103 is also substantially rectangular in top view and formed from a laminate film LF configured by laminating a heat resistant layer LF1, a barrier layer LF2, and a heat seal layer LF3 in that order. The heat seal layer LF3 is commonly formed of a thermoplastic material such as polypropylene. A left sealing section 103a, a right sealing section 103b, and a front sealing section 103c (hereinafter referred to as the “terminal-sealing section 103c”) are formed by integrating the heat seal layer LF3 by thermal fusion bonding such that the left sealing section 103a, right sealing section 103b, and front sealing section 103c are formed continuously with one another. Each of the left sealing section 103a, right sealing section 103b, and front sealing section 103c has a predefined width.

The electric storage element 101 is enclosed in the film package 103 together with an electrolyte. The front portion of each of the terminals 102 is led out from the film package 103 through the terminal-sealing section 103c.

In producing the film package 103, an electric storage element 101 connected to each of a pair of terminals 102 and a rectangular laminate film LF are prepared. Subsequently, the laminate film LF is disposed such that the heat seal layer LF3 faces upwardly. Then, the electric storage element 101 is placed on the laminate film LF in a manner that the respective front potion of each of the terminals 102 is led out from the edge of one side of the laminate film LF.

Subsequently, the laminate film LF is folded in half such that the respective edges of each half of the folded laminate film LF are aligned with one another. Then, the left and right edges of the laminate film LF are heated in a predefined width using a suitable heating device to integrate the opposing surfaces of the left and right edges of the heat seal layers LF3 by thermal fusion bonding to form the left sealing section 103a and the right sealing section 103b. Next, an electrolyte is poured into the inside of the laminate film LF through the front open section thereof, and then the front edges of the laminate film LF are heated in a predefined width such that the opposing surfaces of the front edges of the folded heat seal layers LF3 are integrated with each other by thermal fusion bonding to form the terminal-sealing portion 103c.

The terminal-sealing section 103c is heated in the condition that a part of each of the terminals 102 is sandwiched between the upper and lower heat seal layers LF3 of the folded laminate film LF to integrate the upper and lower heat seal layers LF3, whereby said part of each of the terminals 102 is surrounded with the “integrated heat seal portion” without any gaps (as shown in FIG. 1(B)).

Since the film package 103 may facilitate a thinner electrochemical device RB as compared to other types of electric storage devices, it is desired 1) that such an electrochemical device RB is reflow soldered onto a circuit board together with electronic components such as chip capacitors and/or chip registers; and 2) that such an electrochemical device RB is encapsulated into an IC card.

However, in a typical reflow soldering process, a circuit board to be subjected to reflow soldering is placed into a reflow furnace as an electrochemical device RB is mounted on the circuit board. Therefore, temperature rise occurs to the electrochemical device RB in accordance with the temperature profile for the reflow soldering process, causing the temperature of the electrochemical device RB to rise to the peak or near-peak temperature of the reflow soldering.

In addition, in a typical process for encapsulating an electrochemical device RB into an IC card, the electrochemical device RB is housed into a through hole formed on a core sheet and then a pair of cover seats are heat sealed to the top and bottom surfaces of the core sheet. In this process, temperature rise occurs to the electrochemical device RB in accordance with the temperature profile for the heat sealing, causing the temperature of the electrochemical device RB to rise to the peak or near-peak temperature of the heat sealing.

If the temperature rise is higher than the melting point of the “integrated heat seal portion”, due to the temperature rise, softening or melting occurs to the “integrated heat seal portion” to seal each of the terminals 102 without making any void, and an inner pressure in the film package 103 rises in accordance with vapor pressure of the an electrolyte or other cause.

In other words, the softened or melted “integrated heat seal portion” may be pushed out from the film package 103 due to the inner pressure rise. When the “integrated heat seal portion” is thus pushed out, a void VO connecting the inside and outside of the film package 103 can be formed in the peripheral of the portions on the terminals 102 around the terminal-sealing section 101c, as shown in FIG. 2.

The above-mentioned phenomena can generate voids VO in various sizes in various places. If such voids VO are formed in such a manner to connect the inside and outside of the film package 103, problems may occur such as leakage of the an electrolyte inside of the film package 103 thereby smearing the periphery thereof and lowered performance of the electrochemical device RB due to the leakage of the electrolyte.

### LIST OF RELATED REFERENCES

Patent Literature 1: Japanese Patent Application Publication No. 2008-135443
Patent Literature 2: Japanese Patent Application Publication No. 2005-129236

### SUMMARY

One of the purposes of the present invention is to provide an electrochemical device that can prevent forming in a terminal-sealing section a void connecting the inside and outside of a film package when the electrochemical device is reflow soldered onto a circuit board or encapsulated into an IC card.

To achieve the above-mentioned purpose, there provided is an electrochemical device according to one embodiment comprising a film package formed from one or more laminate films each having a heat seal layer, the film package having a terminal-sealing section formed by integrating heat seal layers of said one or more laminate films with one another by thermal fusion bonding; an electric storage element enclosed in the film package; one or more terminals electrically connected, at one end, to the electric storage element, and the other end of said one or more terminals being led out from the film package through the terminal-sealing section, wherein the front edge of one of the integrated laminate films is projected from the front edge of the other integrated laminate films so that the projected portion of said one of the integrated laminate films defines a support member; wherein the front edge of one of the integrated laminate films is projected from the front edge of the other integrated laminate films so that the projected portion of said one of the integrated laminate films defines a support member; wherein the front edge of one of the integrated laminate films is projected from the front edge of the other integrated laminate films so that the projected portion of said one of the integrated laminate films defines a support member; and wherein each of said one or more terminals is provided with a heat seal auxiliary member formed of a material identical to that of the heat seal layer such that the heat seal auxiliary member surrounds a part of the corresponding terminal, one end of the heat seal auxiliary member being disposed in the terminal-sealing section and being integrated with the terminal-sealing section by the thermal fusion bonding, and the other end of the heat seal auxiliary member projecting outwardly from the terminal-sealing section so as to be disposed on the support member of the film package.

During the process of reflow soldering thus configured electrochemical device to a circuit board, a temperature rise may occur to the electrochemical device in accordance with the reflow soldering temperature profile, and the temperature of the electrochemical device rises to the peak or near-peak temperature of the reflow soldering process. Similarly, during the process of encapsulating the electrochemical device into an IC card, a temperature rise may occur to the electrochemical device in accordance with the heat sealing temperature profile, and the temperature of the electrochemical device rises to the peak or near-peak temperature of the heat sealing process.

In case the increased temperature reaches a temperature higher than the melting point of the heat seal auxiliary member, said other end of each of the heat seal auxiliary members may be melted and spread over the surfaces of each of the terminals. Said other end of each of the heat seal auxiliary members is melted and deformed but the melted portions of the heat seal auxiliary members still remain in or near their initial positions since each of the heat seal auxiliary members is disposed on the corresponding support member.

In parallel with the temperature rise of each of the terminals, the heat is transmitted from each of the terminals to the “integrated heat seal portion” surrounding one portion of the corresponding terminal 12. In addition, as a result of the increased temperature of the surface of the film package, the heat is transmitted inside of the package film, thereby increasing the internal pressure of the film package due to, for example, the increased vapor pressure of the electrolyte. Thus, the “integrated heat seal portion” surrounding said one portion of each of the terminals 12 softens or melts due to the above-mentioned heat transfer, and the soften or melted “integrated heat seal portion” receives the pressure applied outwardly of the package film as a result of the increased internal pressure of the package film.

However, as described above, since the molten materials of each of the heat seal auxiliary members remains in front of the terminal-sealing section corresponding to the terminals, the soften or melted “integrated heat seal portion” is prevented from being pushed out by the outward force exerted to the “integrated heat seal portion” by the increased internal pressure of the package film, thereby preventing forming a void in the terminal-sealing section around the terminals.

Thus, such a void as connecting the inside and outside of the package film is not formed in the terminal-sealing section while the electrochemical device is either reflow-soldered on a circuit board or encapsulated into an IC card, thereby preventing with certainty troubles such as smearing of the periphery of the film package and lowered performance of the electrochemical device due to the leakage of the electrolyte out of the film package.

According to an embodiment of the present invention, any void connecting the inside and outside of the package film is not formed in the terminal-sealing section while the electrochemical device is either reflow-soldered on a circuit board or encapsulated into an IC card, thereby preventing with certainty troubles such as smearing of the periphery of the film package and lowered performance of the electrochemical device due to the leakage of the electrolyte out of the film package.

The above-mentioned and other purposes, configuration characteristic, and advantageous effects of the present invention will be further described below.

### BRIEF DESCRIPTION OF THE DRAWINGS

FIG. 1(A) shows a top view of a conventional electrochemical device; and. FIG. 1 (B) shows an expanded sectional view along with S-S line in FIG. 1(A).

FIG. 2 illustrates the behavior of the heat seal portion of the terminal-sealing section when the electrochemical device shown in FIGS. 1(A) and 1(B) is reflow soldered onto a circuit board or is encapsulated into an IC card.

FIG. 3(A) shows a top view of the electrochemical device in accordance with the first embodiment of the present invention; FIG. 3(B) shows an expanded sectional view along with S11-S11 line in FIG. 3(A); FIG. 3(C) shows an expanded sectional view along with S12-S12 line in FIG. 3(A); and FIG. 3(D) shows an expanded sectional view along with S13-S13 line in FIG. 3(A).

FIGS. 4(A) and 4(B) illustrate the behavior of the heat seal portion of the terminal-sealing section when the electrochemical device indicated in FIG. 3(A) through FIG. 3(D) is reflow soldered onto a circuit board or is encapsulated into an IC card.

FIG. 5 shows a top view of the electrochemical device in accordance with the second embodiment of the present invention.

FIG. 6 shows a top view of the electrochemical device in accordance with the third embodiment of the present invention.

FIG. 7 shows a top view of the electrochemical device in accordance with the fourth embodiment of the present invention.

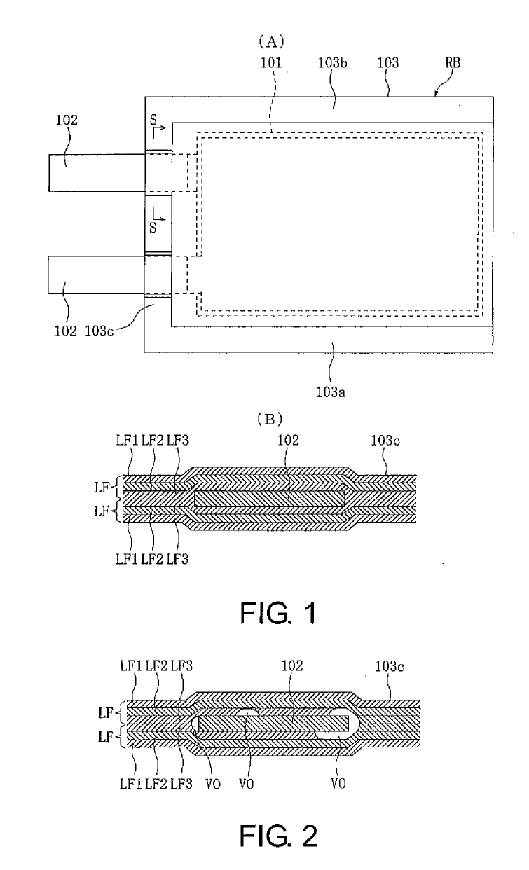

### DETAILED DESCRIPTION OF THE PREFERRED EMBODIMENTS

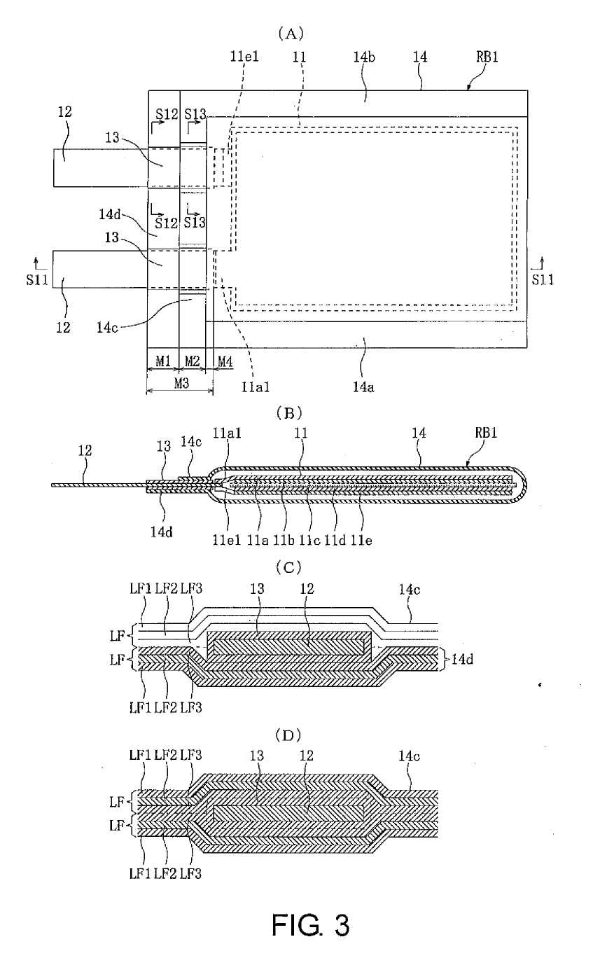

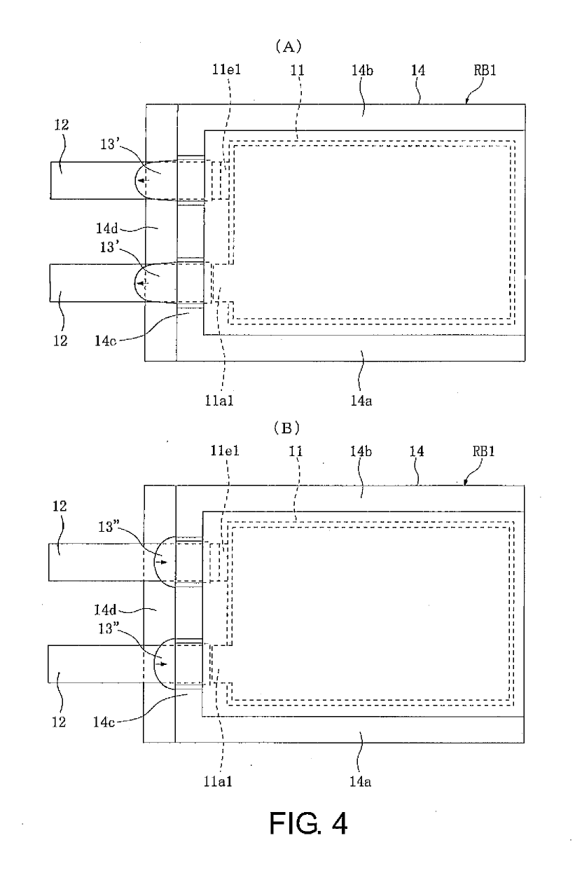

Various embodiments of the present invention will be described below with reference to the accompanying drawings. For ease of describing, the direction toward the viewer, away from the viewer, left, right, top and bottom in FIG. 3 (A) will be referred to as “top,” “bottom,” “front,” “rear,” “left,” and “right” respectively, while the corresponding directions in other drawings are also referred to as “top/” “bottom,” “front,” “rear,” “left,” and “right” respectively.

### First Embodiment

FIGS. 3(A)-3(D) show an electrochemical device RB1 in accordance with the first embodiment of the present invention. The electrochemical device RB1 comprises an electric storage element 11; a pair of terminals 12 each electrically connected to the electric storage element 11; a pair of heat seal auxiliary members 13 disposed on each of the terminals 12; and a film package 14 enclosing the electric storage element 11.

The electric storage element 11 is substantially rectangular in top view. The electric storage element 11 may be configured by laminating a collecting electrode layer 11a, a polarizable electrode layer 11b, and a separate film 11c, a polarizable electrode layer 11d, and a collecting electrode layer 11e in that order. The collecting electrode layers 11a and 11e is each formed of conductive materials such as aluminum or platinum. The thickness of each of the electrode layers 11a and 11e may be 5-50 μm. The polarizable electrode layers 11b and 11d is each formed of active materials such as PAS (PolyAcenic Organic Semiconductive material) or activated carbon. The thickness of each of the polarizable electrode layers 11b and 11d may be 10-100 μm. The separate film 11c is formed of an ion permeable film such as cellulosic film or plastic film. The thickness of the separate film 11c may be 10-50 μm.

The electrode layer 11a has a polarity opposite to that of the collecting electrode layer 11e. A rectangular terminal connection 11a1 is disposed integrally with the collecting electrode layer 11a on the left side of its front edge. A rectangular formed terminal connection 11e1 is disposed integrally with the collecting electrode layer 11e to be on the right side of the front edge thereof. For the convenience of illustration, a five-layered electric storage element 11 is shown in FIG. 3(B). However, more number of layers may be used to the extent that collecting electrode layers, polarizable electrode layers, and separate films are laminated in the above-mentioned order.

Each of the terminals 12 is substantially rectangular in top view. A rear edge of one of the terminals 12 is electrically connected to the terminal connection 11a1 of the electric storage element 11, and a rear edge of the other one of the terminals 12 is electrically connected to the terminal connection 11e1. Each of the terminals 12 is formed of conductive materials such as aluminum or platinum. The thickness of the each of the terminals 12 may be 50-150 μm. A front edge of each of the terminals 12 is plated with a metal such as tin or gold for soldering.

Each of the heat seal auxiliary members 13 is disposed so as to surround a certain portion of the corresponding terminal 12. Each of the heat seal auxiliary members 13 is formed of the same materials as the heat seal layer LF3 (described below). The thickness of each of the heat seal auxiliary members 13 may be 30-50 μm. Each of the heat seal auxiliary members 13 may be provided on the corresponding terminal 12 by applying a certain liquid to the surfaces of the terminals 12 and then curing the same. Each of the heat seal auxiliary members 13 may also be provided by winding a sheet-like material onto the terminals 12.

The film package 14 is substantially rectangular in top view and formed from a laminate film LF. The laminate film LF is configured by laminating a heat resistant layer LF1, a barrier layer LF2, and a heat seal layer LF3 in that order. The heat resistant layer LF1 is formed of thermoplastics such as nylon or polyethylene phthalate. The thickness of the heat resistant layer LF1 may be 10-50 μm. The barrier layer FL2 is formed of metals such as aluminum or metal oxides. The thickness of the barrier layer FL2 may be 10-50 μm. The heat seal layer LF3 is formed of thermoplastics such as polypropylene or modified polypropylene. The thickness of the heat seal layer LF3 may be 30-50 μm.

A left seal 14a, a right seal 14b, and a front seal 14c (hereinafter referred to as the “terminal-sealing section 14c”) are formed on the outer edge of the film package 14. The left seal 14a, a right seal 14b, and front seal 14c are formed continuously with one another by integrating opposing surfaces of the folded heat seal layers LF3 by thermal fusion bonding. Each of the left seal 14a, right seal 14b, and front seal 14c has a predefined width. The film package 14 has a support member 14d formed from the front portion of the lower part of the folded laminate film LF. The front edge of the lower part of the film package 14 is projected outwardly from the front edge of the upper part of the film package 14 such that the supporting member 14d is disposed along with the terminal-sealing section 14c. Thus, a portion of the lower part of the film package 14 projected outwardly from front edge of the opposing upper part of the film package 14 may be referred to as support member 14d. In other words, the front edge of the lower part of the film package 14 (one of the edges of the film package 14 which is provided with the terminal-sealing section 14c) has the support member 14d formed continuously along with the terminal-sealing section 14c and projected outwardly from the upper part of the film package 14.

The electric storage element 11 is enclosed in the film package 14 with an electrolyte (e.g., a liquid electrolyte prepared by mixing triethylmethylammonium fluoroborate with a propylene carbonate solvent or a gelatinous electrolyte prepared by mixing, for example, polyacrylonitrile with said liquid electrolyte). The front potion of each of the terminals 12 and front portion of each of the heat seal auxiliary members 13 is each led out from the film package 14 through the terminal-sealing section 14c. A rear portion of each of the heat seal auxiliary members 13 is disposed within the terminal-sealing section 14c. The seal auxiliary members 13 becomes integrated with the heat seal layers LF3 when opposing surfaces of the heat seal layers LF3 are integrated with each other by thermal fusion bonding. The front side of each of the heat seal auxiliary members 13 is projected forwardly from the terminal-sealing section 14c such that it is disposed on the support member 14d.

As shown in FIG. 3(A), when the projected portion of the support member 14d has a length represented by M1 and the terminal-sealing section 14c has a width represented by M2, the length of the projected portion of the heat seal auxiliary members 13 roughly coincides with M1. The length M3 of each of the heat seal auxiliary members 13 in the front and back direction is slightly greater than the sum of M1+M2. As a result, the rear edge of each of the heat seal auxiliary members is projected inwardly to the film package 14 by the length M4.

In producing the film package 14, an electric storage element 11 connected to each of a pair of terminals 12 with heat seal auxiliary members 13 and a rectangular formed laminate film LF in a predefined size are prepared. Then, the laminate film LF is disposed such that the heat seal layer LF faces upwardly. The electric storage element 11 is placed on the laminate film LF such that the front edge of each of the heat seal auxiliary members roughly coincide with one of the edges of the laminate film LF.

Subsequently, the laminate film LF is folded such that the film edge of the lower part of the folded laminate film LF is projected outwardly from the edge of the upper part of the folded laminate film LF by the length M1. Then, the left and right edges of the folded laminate film LF are heated in a predefined width using a suitable heating device such that opposing surfaces of the heat seal layers LF3 are integrated with each other by thermal fusion bonding in its left and right edges thereof, thereby forming left seal 14a and right seal 14b. Then, inside the thus-prepared pouched-shaped laminate film LF is an electrolyte is poured from the front open portion thereof. Then, the front edges of the folded laminate film LF are heated with a suitable heating device in a predefined width such that opposing surfaces of the heat seat layers LF are integrated with each other by thermal fusion bonding in its front edge thereby forming terminal-sealing section 14c.

The heating process for forming the terminal-sealing section 14c, is performed as the rear portion of each of the heat seal auxiliary members is sandwiched between the upper and lower heat seal layers LF3. Since each of the heat seal auxiliary members 13 is formed of the same material as that of the heat seal layer LF3, the heating process integrates the heat seal layer LF3 with the rear edge of each of the heat seal auxiliary members 13 such that each of the terminals 102 is enclosed with the “integrated heat seal portion” without any void (as shown in FIG. 3(D)).

The thickness of a portion of the terminal-sealing section 14c where the pair of terminals 12 and the rear portions of each of the heat seal auxiliary members 13 exist becomes slightly thicker than the other portion of the terminal-sealing section 14c. Accordingly, if a heating device with a hard heating surface is used to form the terminal-sealing section 14c, some disadvantages may occur. For example, the sealing capability may be lowered than that of the thicker portion. In addition, the “integrated heat seal portion” may protrude from the rear or front edge of the terminal-sealing section 14c. In one embodiment, a heating device with an elastic deformable heating surface may be used for the heating process, thereby forming the terminal-sealing section 14c without causing such disadvantages.

The above-mentioned difference in the thickness of the terminal-sealing section 14c creates a stepped section on the upper and lower surfaces of the terminal-sealing section 14c, as shown in FIG. 3(D), and creates a similar stepped section on the upper and lower surfaces of the support member 14d, as shown in FIG. 3(C). Thus, the front portion of each of the heat seal auxiliary members 13 is held by the stepped section created on the upper surface of the support member 14d, thereby preventing the deviation of the front portion of each of the heat seal auxiliary members 13 in the right and left direction. As a result, the deviation of each of the terminals 12 in the right and left direction may be prevented. For the convenience of illustration, FIGS. 3(C) and 3(D) show a stepped section configured from a series of planar slopes. However, it should be noted that if a heating device with an elastic deformable heating surface is used, the stepped section may be configured from a continuing curved slope.

When the electrochemical device RB1 is reflow soldered onto a circuit board, the front portion of the pair of terminals 12 of the electrochemical device RB1 is folded as necessary, and then the pair of terminals 12 and the external electrodes of electronic components such as chip capacitors and chip registers are placed on corresponding electrode pads provided on the circuit board via a solder cream. Then, the thus-prepared circuit board is placed into a reflow furnace.

A reflow-soldering process is performed on the electrochemical device RB1 provided on the circuit board according to a reflow-soldering temperature profile for reflow soldering, thereby each of the terminals 12 is electrically connected to the corresponding electrode pad. The peak temperature is around 240-260° C. in case of using a lead-free solder. The peak temperature may change depending on the materials used for solder.

In encapsulating the electrochemical device RB1 into an IC card, a core sheet formed of thermoplastics such as polyvinyl chloride or polyethylene phthalate and a pair of cover sheets are prepared. The electrochemical device RB1 is housed into a through hole formed on the core sheet, and each of the cover sheets is overlapped with the corresponding upper and lower surfaces of the core sheet. Then, the thus-overlapped core sheet and cover sheets are heat-sealed under certain pressure using an appropriate heating apparatus. According to one embodiment, an IC module (which may be configured by modularizing an IC with other electronic components) is housed into the through hole formed on the core sheet. In another embodiment, a separate sheet including the IC module may be interposed between the core sheet and lower cover sheet.

A heat-sealing process is performed on the core sheet and the upper and lower cover sheets according to a suitable heat-sealing temperature profile. The heat-sealing process causes each of the sheets to come into intimate contact with each other, thereby encapsulating the electrochemical device RB1 in the IC card. The peak temperature is around 260° C. in case the core sheet and the upper and lower cover sheets are formed of polyethylene phthalate. The peak temperature may change to some extent depending on the materials of the core sheet and the cover sheets.

Thus, a temperature rise may occur to the electrochemical device RB1 in accordance with the reflow soldering temperature profile during reflow-soldering process or the heat-sealing temperature profile during heat-sealing process. In each case, a temperature of the electrochemical device RB1 can rise up to the peak or near-peak temperature.

Since no means for preventing such temperature rise is provided on the front portions of the terminals 12 and heat seal auxiliary members 13 or the support member 14d, their temperatures each rises up to the peak or near-peak temperature within a short period of time. On the other hand, thanks to the heat resistant layer LF1 disposed on the surface of the film package 14 and the barrier layer LF2 disposed inside thereof, the temperatures of the electric storage element 11 and the electrolyte encapsulated in the film package rise to the same level as that of the front portion of each of the terminals 12 with a delay.

For example, assuming that each of the terminals 12 is formed of aluminum and each of the heat seal auxiliary members 13 and the heat seal layer LF3 of the support member 14d are formed of polypropylene (melting point 170° C.), the increased temperature, which can become higher than the melting point of the heat seal auxiliary members, can melt the front portion of each of the heat seal auxiliary members and the heat seal layer LF3 of the support member 14d.

As a result, the front portion of each of the heat seal auxiliary members 13 is melted and spread over the surface of each of the terminals 12, as represented by the reference number 13′. Since the front portion of each of the heat seal auxiliary members 13 is disposed on the corresponding support member 14 and there exists molten material of the heat seal layers LF3 on the support member 14, the front portion of the heat seal auxiliary members 13 is melted and deformed but the melted material of the heat seal auxiliary members 13 still remains in or near its initial position.

In parallel with the temperature rise of each of the terminals 12, the heat is transmitted from each of the terminals 12 to the “integrated heat seal portion” surrounding one portion of the corresponding terminal 12. In addition, as a result of the increased temperature of the surface of the film package 14, the heat is transmitted inside of the package film 14 through the heat resistant layer LF1 and the barrier layer LF2, thereby increasing the internal pressure of the film package 14 due to, for example, the increased vapor pressure of the electrolyte. Thus, the “integrated heat seal portion” surrounding said one portion of each of the terminals 12 softens or melts due to the above-mentioned heat transfer, and the soften or melted “integrated heat seal portion” receives the pressure applied outwardly of the package film 14 as a result of the increased internal pressure of the package film 14.

However, as described above, since the molten material of each of the heat seal auxiliary members 13 remains in front of the terminal-sealing section 14c corresponding to each of the terminals 12, the soften or melted “integrated heat seal portion” is prevented from being pushed out by the outward force exerted to the “integrated heat seal portion” by the increased internal pressure of the package film 14, thereby preventing forming a void as shown in FIG. 2 in the terminal-sealing section 14c around the terminals 12.

Once the reflow-soldering temperature profiles or heat-sealing temperature profile turns into the cooling phase, the melted materials of front portion of each of the heat seal auxiliary members 13, each of which is represented by reference number 13″, is cured in round shape such that each the front edge of the cured heat seal auxiliary members 13 is shrank towards the terminal-sealing section 14c, and the “integrated heat seal portion” surrounding the portion of each of the terminals 12 is also cured while maintaining its original shape.

Thus, such a void as connecting the inside and outside of the package film 14 is not formed in the terminal-sealing section 14c while the electrochemical device RB1 is either reflow-soldered on a circuit board or encapsulated into an IC card, thereby preventing with certainty troubles such as smearing of the periphery of the film package 14 and lowered performance of the electrochemical device RB1 due to the leakage of the electrolyte out of the film package 14.

The electrochemical device RB1 according to one embodiment has an increased thickness of the “integrated heat seal portion” surrounding one portions of each of the terminals 12 in the terminal-sealing section 14c without making any void. The increased thickness may delay the softening or melting of the “integrated heat seal portion”, thereby effectively preventing an outflow of the “integrated heat seal portion”.

### Second Embodiment

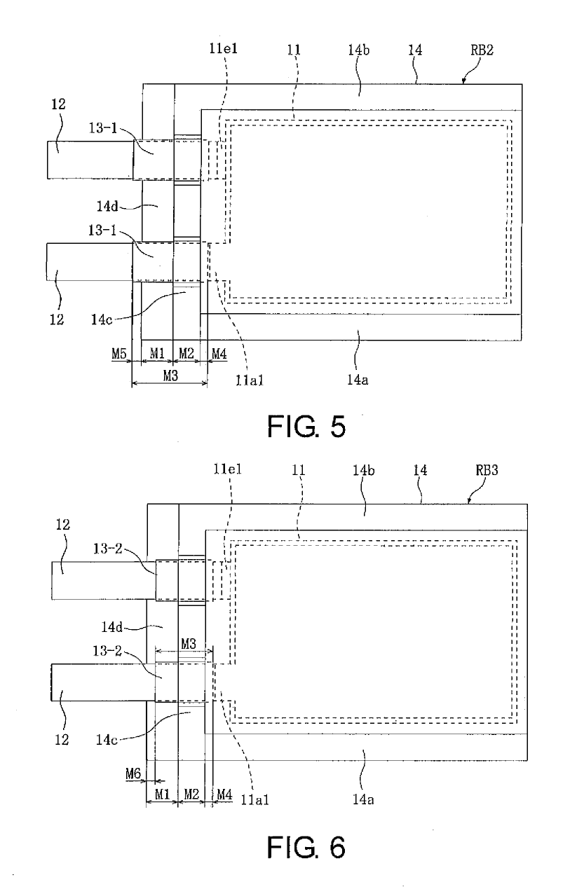

FIG. 5 shows an electrochemical device RB2 in accordance with the second embodiment of the present invention. The electrochemical device RB2 differs from the electrochemical device RB1 according to the first embodiment in that the electrochemical device RB2 is provided with heat seal auxiliary member 13-1, which has the length M3 in the front and back direction longer than that of the heat the seal auxiliary members 13 and, as a result, the front edge of the heat seal auxiliary member 13-1 is projected from the front edge of the support member 14d by the length of M5. Thus, the length of the projected portion of the heat seal auxiliary member 13-1 from the terminal-sealing section 14c (M1+M5) is longer than the length of the projected portion of the support member 14d (M1).

The electrochemical device RB2 may obtain similar advantageous effects to the electrochemical device RB1.

### Third Embodiment

FIG. 6 shows an electrochemical device RB3 in accordance with the third embodiment of the present invention. The electrochemical device RB3 differs from the electrochemical device RB1 according to the first embodiment in that the electrochemical device RB3 is provided with heat seal auxiliary member 13-2, which has the length M3 in the front and back direction shorter than that of the heat seal auxiliary members 13, and, as a result, the front edge of the front edge of the heat seal auxiliary member 13-2 is set back from the front edge of the support member 14d by the length of M6. Thus, the length of the projected portion of the heat seal auxiliary member 13-2 from the terminal-sealing section 14c (M1−M6) is shorter than the length of the projected portion of the support member 14d (M1).

The electrochemical device RB3 may obtain similar advantageous effects to the electrochemical device RB1.

### Fourth Embodiment

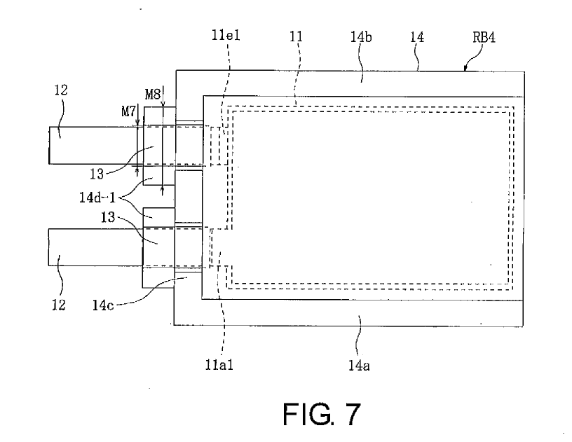

FIG. 7 shows an electrochemical device RB4 in accordance with the third embodiment of the present invention. The electrochemical device RB4 differs from the electrochemical device RB1 according to the first embodiment in that the electrochemical device RB4 is provided with a pair of support members 14d-1 each aligned with the front portion of each of the seal auxiliary members 13 instead of the support member 14 wherein each of the supports 14d-1 is formed in the width of M8 larger than the width M7 of the front portion of the heat seal auxiliary members 13 and the front portion of each of the heat seal auxiliary members 13 is disposed at the center of each of the supports 14d-1 in the right and left direction. Each of the supports 14d-1 is easily formed by preparing a rectangular formed laminate film LF having a pair of ears corresponding to the support members 14d-1.

The electrochemical device RB4 may obtain similar advantageous effects to the electrochemical device RB1.

In one embodiment, as shown in FIG. 7, the electrochemical device RB4 is formed such that the length of front portion of each of the heat seal auxiliary members 13 projected from the terminal-sealing section 14c coincides with that of each of the projected portions of the pair of support members 14d-1. In another embodiment, as with the electrochemical device RB2 according to the second embodiment, the electrochemical device RB4 is provided with a pair of heat seal auxiliary members longer in the right and the left direction than the heat seal auxiliary members 13 of the electrochemical device RB1 such that the front portion of each of the pair of heat seal auxiliary members is projected from the front edge of corresponding support members 14d-1. In yet another embodiment, as with the electrochemical device RB3 according to the third embodiment, the electrochemical device RB4 is provided with a pair of heat seal auxiliary members shorter in the right and the left direction than the heat seal auxiliary members 13 of the electrochemical device RB1 such that the front portion of each of the pair of heat seal auxiliary members is set back from the front edge of the corresponding support member 14d-1.

### Other Embodiments

(1) In the first through the fourth embodiments (electrochemical devices RB1 through RB4), the film package 14 is formed by folding a rectangular formed laminated film to first form the left seal 14a and right seal 14b and then to second form the terminal-sealing section 14c. In another embodiment, the film packages 14 are formed from a pair of separate rectangular films LF by overlapping the pair of laminate films LF to first form a left seal, a right seal, and a rear seal and then to second form a terminal-sealing section. Such electrochemical devices may also obtain similar advantageous effects to the electrochemical device RB1.

(2) In the first embodiment through the fourth embodiment (electrochemical devices RB1 through RB4), the film package 14 is formed from a three-layered laminate film LF. In another embodiment, more or less number of layers may be used to form a laminate film LF to the extent that the resulting laminate film LF includes a heat seal layer on its one surface. Such electrochemical devices may obtain similar advantageous effects to the electrochemical device RB1.

(3) In the first embodiment through the fourth embodiment (electrochemical devices RB1 through RB4), the rear edges of each of the heat seal auxiliary members 13 projects inwardly to the package 14 may have any length. In another embodiment, the pair of heat seal auxiliary members 13 may be formed such that the rear edges of each of the heat seal auxiliary members 13 do not project inwardly to the package 14 (i.e., the length M4 may be near zero). Such electrochemical devices may obtain similar advantageous effects to the electrochemical device RB1.

### INDUSTRIAL APPLICABILITY

Various embodiments of the present invention may be applied to various kinds of electrochemical devices such as electric double layer capacitors, lithium ion capacitors, redox capacitors, and lithium ion batteries. Those electrochemical devices may achieve the above-mentioned advantageous effects.

### LIST OF REFERENCE NUMBERS

RB1, RB2, RB3, and RB4: Electrochemical device
11: Electric storage element
12: Terminal
13, 13-1, and 13-2: Heat seal auxiliary member
14: Film Package
14a, 14b, and 14c: Seal
14d and 14d-1: Support
LF: Laminate film
LF3: Heat seal layer

What is claimed is:

1. An electrochemical device comprising:
a film package formed from one, or more laminate films each having a heat seal layer, the film package having a terminal-sealing section formed by integrating heat seal layers of said one or more laminate films with one another by thermal fusion bonding;
an electric storage element enclosed in the film package;
one or more terminals electrically connected, at one end, to the electric storage element, the other end of said one or more terminals being led out from the film package through the terminal-sealing section;
wherein the front edge of one of the integrated laminate films is projected from the front edge of the other integrated laminate films so that the projected portion of said one of the integrated laminate films defines a support member;
wherein each of said one or more terminals is provided with a heat seal auxiliary member formed of a material identical to that of the heat seal layer such that the heat seal auxiliary member surrounds a part of the corresponding terminal, one end of the heat seal auxiliary member being disposed in the terminal-sealing section and being integrated with the terminal-sealing section by the thermal fusion bonding, and the other end of the heat seal auxiliary member projecting outwardly from the terminal-sealing section so as to be disposed on the support member of the film package.

2. The electrochemical device of claim 1, wherein the support member of the film package is formed continuously along the terminal-sealing section.

3. The electrochemical device of claim 1, wherein the support member of the film package is formed on a part of the terminal-sealing section so as to correspond to said other end of the heat seal auxiliary member, the supporting member having a width larger than that of said other end of the heat seal auxiliary member.

4. The electrochemical device of claim 1, wherein a projecting portion of the other end of the heat seal auxiliary member which projects outwardly from the terminal-sealing section has a length coinciding with that of the support member.

5. The electrochemical device of claim 1, wherein a projecting portion of the other end of the heat seal auxiliary member which projects outwardly from the terminal-sealing section has a length longer than that of the support member.

6. The electrochemical device of claim 1, wherein a projecting portion of the other end of the heat seal auxiliary member which projects outwardly from the terminal-sealing section has a length is shorter than that of the support member.
